(19) United States
(12) Patent Application Publication
(10) Pub. No.: US 2024/0303483 A1
(43) Pub. Date: Sep. 12, 2024

(54) METHOD FOR PARTITIONING TIME SERIES

(71) Applicants: SAFRAN ELECTRONICS & DEFENSE, Paris (FR); CENTRE NATIONAL DE LA RECHERCHE SCIENTIFIQUE, Paris (FR)

(72) Inventors: Badr MANSOURI, MOISSY-CRAMAYEL (FR); Alexandre EID, MOISSY-CRAMAYEL (FR); Guy CLERC, MOISSY-CRAMAYEL (FR)

(21) Appl. No.: 18/258,798

(22) PCT Filed: Dec. 9, 2021
(86) PCT No.: PCT/EP2021/085115

§ 371 Date: Jun. 21, 2023

(30) Foreign Application Priority Data
Dec. 21, 2020 (FR) FR2013861

(51) Int. Cl. G06N 3/08

(52) U.S. Cl. CPC G06N 3/08

(57) ABSTRACT

A partitioning method includes the steps of acquiring an observation matrix including time series (x₁ x₂, . . . , xₚ); for each time series calculating a distance matrix comprising distance values between the elements of the time series, then generating the primary image on the basis of the distance matrix; implementing a learning algorithm for segmenting the primary image so as to obtain a segmented image; defining, on the basis of the segmented image, a primary boundary signal representative of the boundaries; and merging the primary boundary signals in order to obtain a global boundary signal, and defining classes on the basis of the global boundary signal.

### BACKGROUND OF THE INVENTION

A Health-Monitoring process, commonly called PHM (Prognostics & Health Management), although conditional maintenance, predictive maintenance or provisional maintenance are also referred to, but less frequently, is used to predict the degradation of equipment or of a system, in particular in the aeronautics field.

The predictive maintenance process thus makes it possible to avoid a breakdown, to optimise the useful life, to predict and plan the maintenance operations (and a possible removal), and therefore to reduce the costs of maintenance operations of the equipment or of the system.

The predictive maintenance process comprises five main steps: a data acquisition step, a data processing (or pre-conditioning) step, a signature extraction step, a diagnostic step and a prognostic step.

The data acquisition step consists of acquiring data produced by sensors measuring parameters representative of a performance of the equipment or of the system. The data acquisition is, for example, performed via tests, or by downloading on the equipment or on the system, when this is operational.

The data pre-conditioning step consists in particular of filtering data to remove the measurement noise present in the data.

The signature extraction step consists of processing the data to extract one or more signatures from it, representative of the state of the equipment or of the system and, optionally, of a degradation of the operation of the equipment or of the system.

The diagnostic step consists of determining the health state of the equipment or of the system currently from among a set of severity classes (failure modes), each associated with a severity level.

The prognostic step consists of estimating the remaining useful life (or RUL) of the equipment or of the system.

It is noted that it is possible to avoid one or more steps, or mix several steps. For example, if only deep learning algorithms are used for the diagnostic step and the prognostic step, it is not necessary to carry out the signature extraction step (and this is even advised against).

Patent application FR1907561, filed on May 7, 2019, describes a method for estimating the remaining life duration of equipment such as an electromechanical actuator. This document discloses a partitioning method, wherein the number of severity classes used is determined by the joint optimisation of a temporal coherence criterion and of an energy criterion. This method requires initially to define a number of classes “intuitively”, to evaluate the temporal coherence and the convergence level of the energy criterion associated with this initial number of classes, then, if necessary, to repeat these steps until obtaining a satisfactory temporal and coherence a satisfactory convergence level of the energy criterion.

This method is effective, but requires relatively specific knowledge initially about the data of the database used and, in particular, about the failure modes of the equipment or of the systems considered.

### Aim of the Invention

The invention aims for a partitioning method which can be implemented more systematically on various databases, and without requiring “a priori” knowledge relating to the severity classes present in the observations of the database used.

### SUMMARY OF THE INVENTION

In view of achieving this aim, a partitioning method is proposed, implemented in a processing unit and comprising the steps of:
acquiring an observation matrix produced from a database comprising observations of parameters made on at least one piece of equipment, the observation matrix comprising time series, each comprising elements which are observations of a parameter;
for each time series:
   calculating a distance matrix comprising distance values between the elements of the time series, then generating a primary image (20, 21) on the basis of said distance matrix, comprising pixels having levels representative of the distance values of the distance matrix;
   implementing a learning algorithm for segmenting the primary image so as to obtain a segmented image comprising patterns delimited by boundaries, and producing a segmented matrix comprising levels of pixels of the segmented image;
   defining a primary boundary signal representative of the boundaries from the segmented matrix;
merging the primary boundary signals to obtain a global boundary signal, and defining classes from the global boundary signal.

The calculation of a distance matrix associated with each time series, and the representation of the distance matrices by images, make it possible to extract the group information in the time series systematically and fully automatically. The method according to the invention therefore requires knowledge initially relating to the failure modes of the equipment, and its use can be expanded to different types of equipment or of systems.

In addition, a partitioning method such as described above is proposed, wherein the distance matrix is a Gram matrix, such that:

$$𝒢 ( {𝕏}_{i} ) = [ \begin{matrix}d ( {x}_{1}^{i} , {x}_{1}^{i} ) & d ( {x}_{1}^{i} , {x}_{2}^{i} ) & … & d ( {x}_{1}^{i} , {x}_{n}^{i} ) \\ d ( {x}_{2}^{i} , {x}_{1}^{i} ) & d ( {x}_{2}^{i} , {x}_{2}^{i} ) & … & d ( {x}_{2}^{i} , {x}_{n}^{i} ) \\ ⋮ & ⋮ & ⋮ & ⋮ \\ d ( {x}_{n}^{i} , {x}_{1}^{i} ) & d ( {x}_{n}^{i} , {x}_{2}^{i} ) & … & d ( {x}_{n}^{i} , {x}_{n}^{i} )\end{matrix} ] ,$$

where [symbol] ᵢ is a time series, the (xₖⁱ)_{1≤k≤n} are the elements of said time series, and where d(xₗⁱ,xₘⁱ) is a distance value between xₗⁱ and xₘⁱ, with 1≤l≤n and 1≤m≤n.

In addition, a partitioning method such as described above is proposed, wherein the patterns are squares having a diagonal combined with a portion of a diagonal of the primary image.

In addition, a partitioning method such as described above is proposed, wherein the segmentation of the primary image consists of determining a learning probability of the pixels of the primary image to a first class representing the patterns or to a second class representing a background of the primary image.

In addition, a partitioning method such as described above is proposed, wherein the learning algorithm is a U-NET-type convolutional neural network.

In addition, a partitioning method such as described above is proposed, further comprising the step of generating artificial primary images from simulation functions, and to train the learning algorithm by using the artificial primary images.

In addition, a partitioning method such as described above is proposed, wherein the simulation functions are piecewise continuous constant functions or multi-slope increasing functions.

In addition, a partitioning method such as described above is proposed, wherein the definition of the primary boundary signal comprises the step of calculating a statistical function on sets of elements which each comprise elements of one of the anti-diagonals of the segmented matrix.

In addition, a partitioning method such as described above is proposed, further comprising the step of filtering the primary boundary signal by using an sliding window iterative method.

In addition, a partitioning method such as described above is proposed, wherein the merging of the primary boundary signals consists of summing the primary boundary signals to obtain a summed boundary signal, then of estimating a empirical density function of the summed boundary signal to produce the global boundary signal.

In addition, a partitioning method such as described above is proposed, wherein, to calculate the empirical density function, a first formula is used in the case where the observations of parameters have been made on one same piece of equipment or system, and a second formula is used in the case where the observations of parameters have been made on distinct equipment or systems representing embodiments not identically distributed.

In addition, a partitioning method such as described above is proposed, wherein the first formula is:

$$\hat{d} ( x ) = \frac{1}{n h} {\sum }_{i = 1}^{n} K ( \frac{x - {x}_{i}}{h} ) ,$$

where the xᵢ are elements of the summed boundary signal, K is a kernel function, h represents a bandwidth of the kernel function and n is a number of elements of each time series.

In addition, a partitioning method such as described above is proposed, wherein the second formula is:

$$\hat{d} ( {x}^{1} , … , {x}^{m} ) = \frac{1}{n {h}_{1} … {h}_{n}} {\sum }_{i = 1}^{n} \{ {\prod }_{j = 1}^{m} K ( \frac{{x}^{j} - {f}_{i j}}{{h}_{j}} ) \} ,$$

where the fᵢⱼ are elements of the primary boundary signals, K is a kernel function, the h₁ . . . hⱼ . . . hₙ represent a bandwidth of the kernel function, m is a number of embodiments not identically distributed and n is a number of elements of each time series.

In addition, a partitioning method such as described above is proposed, wherein the second formula is:

$$\hat{d} ( {x}^{1} , … , {x}^{m} ) = \frac{1}{n {h}_{1} … {h}_{n}} {\sum }_{i = 1}^{n} \{ {\prod }_{j = 1}^{m} {Φ}_{j} K ( \frac{{x}^{j} - {x}_{i j}}{{h}_{j}} ) \} ,$$

where the fᵢⱼ are elements of the primary boundary signals, K is a kernel function, the h₁ . . . hⱼ . . . hₙ represent a bandwidth of the kernel function, m is a number of embodiments not identically distributed, n is a number of elements of each time series, and wherein the following is had:

$${Φ}_{i} , i ∈ 〚 1 ; m 〛 and {\sum }_{i = 1}^{m} {Φ}_{i} = 1.$$

In addition, a processing unit is proposed, comprising at least one processing component, wherein the partitioning method which has just been described is implemented.

Also, a processing unit such as described above is proposed, comprising a GPU, wherein at least one learning algorithm is implemented to segment the primary images.

Also, a computer program comprising instructions which make the processing unit such as described above execute the steps of the partitioning method which has just been described is proposed.

A recording medium which can be read by a computer is proposed, on which the computer program which has just been described is recorded.

The invention can be better understood in the light of the following description of a particular, non-limiting embodiment of the invention.

### BRIEF DESCRIPTION OF THE DRAWINGS

Reference will be made to the accompanying drawings, wherein;

FIG. 1 represents a turbojet and electromechanical actuators of a thrust reverser;

FIG. 2 represents steps of the partitioning method according to the invention;

FIG. 3 represents a processing unit, wherein the partitioning method is implemented;

FIG. 4 is a figure similar to FIG. 2, but more detailed;

FIG. 5 represents a primary image obtained for the jack LLA;

FIG. 6 represents a primary image obtained for the jack URA;

FIG. 7 represents a “simple” discrete convolution product;

FIG. 8 represents the architecture of a U-NET-type convolutional neural network;

FIG. 9 represents a piecewise continuous constant function, an artificial primary image and the associated mask;

FIG. 10 represents a segmented image obtained from the image of FIG. 5;

FIG. 11 represents a segmented image obtained from the image of FIG. 6;

FIG. 12 represents the images of FIGS. 5 and 10 and a graph illustrating the result of the segmentation;

FIG. 13 represents the steps implemented to define the primary boundary signals and the global boundary signal;

FIG. 14 represents the steps implemented to obtain a primary boundary signal;

FIG. 15 represents the filtering of a primary boundary signal;

FIG. 16 represents a graph comprising a primary boundary signal (after filtering) obtained for the jack LLA;

FIG. 17 represents a graph comprising the summed boundary signal obtained for the jack LLA;

FIG. 18 represents two graphs comprising curves illustrating the estimation of the density by the kernel function of the summed boundary signal;

FIG. 19 represents a graph comprising the signal of FIG. 17 and a curve of the empirical density calculated with a Gaussian kernel function.

### DETAILED DESCRIPTION OF THE INVENTION

In this case, the invention is applied and has been validated experimentally on the jacks (electromechanical actuators) of an electrical actuation system of the thrust reversers of an airplane. This system is called ETRAS®.

The ETRAS® system makes it possible to open a part of the nacelle of each turbojet of the airplane to deviate the airflow from said turbojet to the front of the airplane. A braking of the airplane thus results from this, when the airplane is on the ground, which is added to the braking performed by the brakes equipping the braked wheels of the airplane. Each brake of a braked wheel in this case comprises a stack of carbon disks and hydraulic actuators which apply a braking force on the stack of carbon disks.

The ETRAS® system is mainly used during the landing of the airplane, but can be used to help the emergency braking during an aborted take-off (ATO).

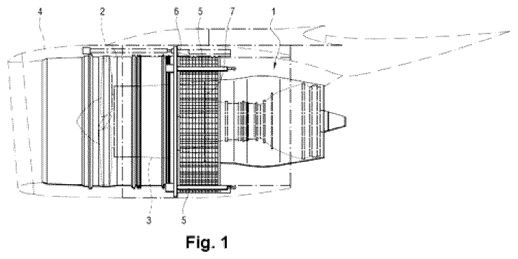

A part of the ETRAS® system is represented in FIG. 1. The turbojet 1 comprises a propeller 2 and a body 3. The nacelle 4 surrounds the turbojet 1. The ETRAS® system comprises, for each nacelle 4, four jacks 5 (only two can be seen in FIG. 1), as well as a harness 6.

During the opening of the airbrake, the part of the nacelle 4 integral with the nuts of the ball screws of the jacks 5 translates to show the grille 7 and enable the deviation of the airflow captured by the front of the turbojet 1.

The four jacks 5 are named, in this case, by the following acronyms: URA (Upper Right Actuator), ULA (Upper Left Actuator), LRA (Lower Right Actuator) and LLA (Lower Left Actuator).

Accelerometers are installed on each of these jacks 5. The accelerometers measure the vibration levels undergone by the jacks 5.

The system has been urged during numerous opening/closing cycles, under different conditions of use, and in particular, during tests implemented for the qualification of the ETRAS® system. The data from the endurance cycles and therefore the signals measured during said cycles have made it possible to construct the database used to train and validate the models which have just been described.

The implementation of the predictive maintenance process requires to characterise the health state of a piece of equipment or of a system, i.e. its degree of degradation or its remaining useful life.

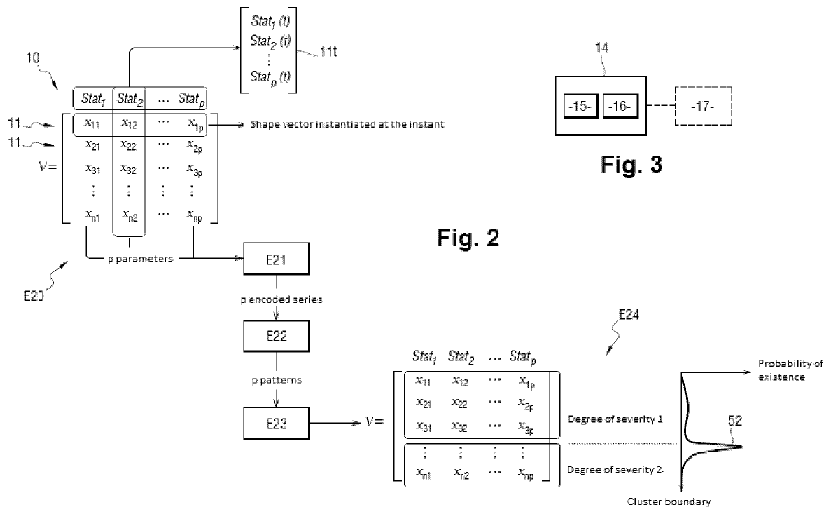

First, in reference to FIG. 2, the general principle of the invention is described.

The health state of a piece of equipment (or of a system comprising several pieces of equipment which interact), is characterised by a certain numberp of parameters calculated from signals measured on said equipment.

The database used makes it possible to produce an observation matrix 10 (step E20).

The observation matrix 10 comes from recordings of measured signals, broken down into n operating cycles. The p parameters Stat₁, Stat₂, . . . , Statₚ are calculated on each operating cycle, thus modifying the time scale.

The concatenation of these new signals makes it possible to constitute the observation matrix 10: the observation matrix 10 is created by considering these p parameters calculated on the n successive operating cycles. The observation matrix 10 has the size of n×p:n lines and p columns.

A shape vector 11 is defined as being a line of the observation matrix, i.e. the instantiation of all the parameters to the cyclei ∈ [symbol] 1,n [symbol] . Each shape vector 11 is therefore of size 1×p. In FIG. 2, the shape vector 11t instantiated at the instant t is seen. The shape vector is a signature of the process.

To quantify the health state of the system, the notion of degree of severity of a defect is introduced, and the successive values of the shape vector are partitioned according to this degree of severity. The hypothesis is used, according to which a defect of the system progressively gets worse, and according to which the system does not improve during its useful life (no corrective maintenance).

This hypothesis makes it possible, for example, to provide the duration between two maintenance periods by considering the start of the period as being the initial state, or to estimate the useful life of a system without corrective maintenance.

One of the major innovations provided by the invention is a new time series partitioning (or clustering) method. This partitioning uses an unsupervised learning algorithm which brings together points according to a measurement of similarity or more specifically, of a distance.

To do this, each parameter of the shape vector (namely time series) is encoded in the form of an image (step E21), and a learning algorithm is used to implement a shape recognition making it possible to recognize patterns in each image, as well as boundaries delimiting the patterns (step E22). Thus, a primary boundary signal representative of the boundaries is produced, and the primary boundary signals are merged (step E23) to produce a global boundary signal from which the severity classes are defined (step E24).

The merging of these primary boundary signals enables the creation of a meta-signature representing the plausibility of the boundaries of the severity classes.

All the operations described are, in this case, implemented in an electronic processing unit 14, which can be seen in FIG. 3, which comprises at least one processing component 15 adapted to execute instructions of a program to implement the partitioning method according to the invention. The program is stored in at least one memory 16 of the processing unit 14.

The processing component (s) 15 comprise, for example, a processor, a GPU (Graphics Processing Unit), a DSP (Digital Signal Processor), a microcontroller, or a programmable logic circuit, such as an FPGA (Field Programmable Gate Arrays) or an ASIC (Application Specific Integrated Circuit).

The processing unit 14 acquires the measured signals which are stored in the database 17, implements processings on these measured signals, and stores the result of these processings in the memory 16. Initially, the database 17 is composed of unlabelled data coming from measurements taken on test equipment (the jacks 5). This processing is therefore not implemented directly on equipment in operation (commissioned), but the results of the learning will make it possible to estimate the level of severity of defects and the remaining useful life of equipment in operation. The data obtained in operation will then be labelled and introduced into the database 17 to enhance it.

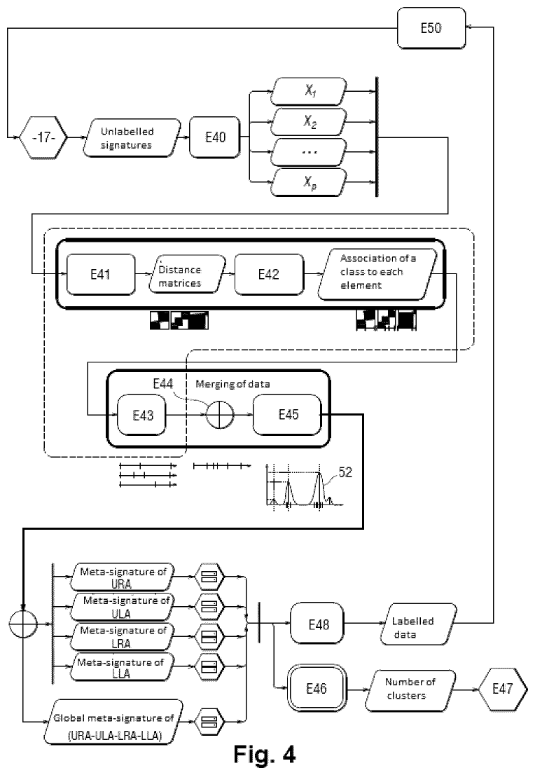

Now, each of these steps are described in a more detailed manner, in reference to FIG. 4 and to the following figures.

The processing unit 14 extracts the unlabelled signatures from the database 17, and separates the independent embodiments (step E40) to produce the time series x₁, x₂, . . . , xₚ.

A set of p time series [symbol] ={ [symbol] ₁, [symbol] ₂, . . . , [symbol] ₚ} is obtained, corresponding to the p parameters of the shape vector making it possible to monitor the state of the system.

Each time series contains n samples, such that the following is had, for j∈ [symbol] 1;p [symbol] :

xⱼ=[x₁ⱼ, x₂ⱼ, . . . , xₙⱼ]^{T}.

Each time series is therefore associated with one of the parameters and comprises elements which are observations of said parameter. Each time series comprises n observations (measurements) of said parameter.

The observation matrix therefore comprises p time series x₁, x₂, . . . , xₚ which form the columns of said observation matrix.

The principle of grouping data together is based on the minimisation of an intra-class distance (objects sharing similar properties) and the maximisation of an extra-class distance (objects with heterogenic properties).

However, this measurement of local similarity must be extended to capture the global dynamics of the signal. A measurement of distance is therefore used between one point and all the other points of the series (therefore, for each of the n samples), n distinct distances thus being able to be calculated. A sampled signal of n points thus causes the calculation of n² different distances, which can be represented in a matrix form.

For each time series, the processing unit 14 calculates a distance matrix (step E41). The distance matrix is a Gram matrix, the elements of which are distance values between the elements of the time series.

For each time series, the distance matrix is a square matrix of size n×n which is created from a series to n samples (the measurements of the parameter) referenced (xᵢ)_{1≤i≤n}.

Each element of the distance matrix, indexed by the pair(i,j)_{1≤i≤n,1≤j≤n}, is thus obtained by calculating the scalar product between xᵢ and xⱼ. In other words, each element is the result of a scalar product between a point and those within its vicinity. The Euclidean standard associated with the scalar product defined above is calculated by applying the square root to all the elements. The distance matrix is therefore constituted of Euclidean distances.

It is noted that, although the Euclidean distance is used in this case, other mathematical distances can be used, according to the dynamics to be highlighted. For example, the Mahalanobis distance could be used.

A matrix representation of said time series is therefore constructed, for each time series. The aim is to cluster the measurements together according to the similarities which consider both the local dynamics and the global dynamics of the time series.

The distance matrix can be written as follows:

$$𝒢 ( {𝕏}_{i} ) = [ \begin{matrix}d ( {x}_{1}^{i} , {x}_{1}^{i} ) & d ( {x}_{1}^{i} , {x}_{2}^{i} ) & … & d ( {x}_{1}^{i} , {x}_{n}^{i} ) \\ d ( {x}_{2}^{i} , {x}_{1}^{i} ) & d ( {x}_{2}^{i} , {x}_{2}^{i} ) & … & d ( {x}_{2}^{i} , {x}_{n}^{i} ) \\ ⋮ & ⋮ & ⋮ & ⋮ \\ d ( {x}_{n}^{i} , {x}_{1}^{i} ) & d ( {x}_{n}^{i} , {x}_{2}^{i} ) & … & d ( {x}_{n}^{i} , {x}_{n}^{i} )\end{matrix} ] ,$$

where [symbol] ᵢ is a time series, the (xₖ)_{1≤k≤n} are the elements of said time series, and where d(xₗⁱ,xₘⁱ) is a distance value between xₗⁱ and xₘⁱ, with 1≤l≤n and 1≤m≤n.

Certain fundamental properties can be deduced from the structure of the distance matrix.

First, the distance matrix is symmetrical and constituted of positive elements.

Indeed, the distance matrix [symbol] is constituted of scalar products. The scalar product being commutative, the following is had:

∉(i,j)∈ [symbol] 1;n [symbol] ², (xᵢ|xⱼ)=(xⱼ|xᵢ).

The distance matrix [symbol] is therefore symmetrical. In addition, by definition of the Euclidean distance, all the parameters of [symbol] are positive.

Moreover, the distance matrix being symmetrical, the diagonal is an axis of symmetry of the matrix and it is constituted of zero elements.

In this case, the processing unit 14 standardises all the elements of the distance matrix in the interval [0;1].

The processing unit 14 thus generates from the distance matrix, a primary image comprising pixels having levels representative of the distance values of the distance matrix.

The pixel levels are, in this case, grey levels.

The primary images being representations of distance matrices, they have one single channel.

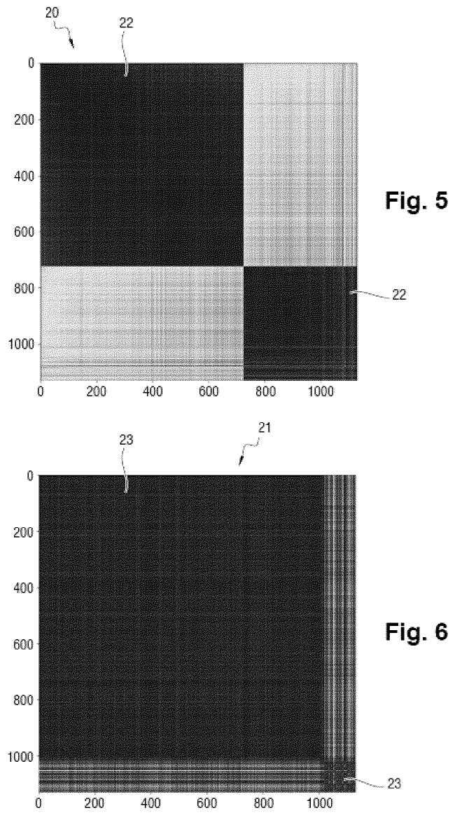

The primary image 20 of FIG. 5 is obtained from averages of the vibratory signal (the parameter) measured on the LLA over 1130 cycles.

The primary image 21 of FIG. 6 is obtained from minima of the vibratory signal (the parameter) measured on the URA over 1130 cycles.

The symmetrical structure is distinguished in FIG. 5, and it is distinguished in FIG. 6.

The signals used are noisy. This noise is at the origin of the rays in the image resulting from the distance matrix.

In the image of FIG. 5, two groups of pixels can be seen, forming two squares 22 separated by a boundary located between 700 and 800 cycles. These squares 22 represent the zones of distances close to 0. They therefore show the low variation of the value of the parameter over time. The contrasted boundaries themselves show the sudden variation of the signal. Also, two squares 23 are distinguished in FIG. 6.

At the almost intra-group variance, the vibratory signals have the dynamic of piecewise continuous constant functions. The jump in continuity is made when the equipment (the jack) passes from a degree of severity of failure to another. The return to a lesser degree of severity is impossible if no maintenance is performed on the jack.

The hypothesis is made that the size of the zones decreases as they age, since the latter accelerates. This information could subsequently be integrated in the prognostic algorithm.

It is noted that by using the representation of a matrix as an image, it is possible to extract the information from groups in a time series. This matrix being symmetrical, it is advantageous to use a method of compressing the information to minimise the computational load of such a method. For example, only the upper triangular part could be preserved (and in particular, by transforming a triangular matrix into a square matrix). The results of detecting degrees of severity are not impacted.

This symmetry will be utilised below for generating artificial data making it possible to overcome the lack of real data, during a design phase, for example.

The learning model is thus used to recognise one or more patterns in each primary image, and to produce a primary boundary signal representative of boundaries delimiting said patterns (step E42).

The learning model implements the principle of semantic segmentation. Thus, a computing machine vision method is used, which consists of associating each pixel of a primary image to a class. In this case, two classes are distinguished:
a first class represents square patterns having a diagonal combined with a portion of the diagonal of the primary image;
a second class which represents the background of the primary image, and therefore the noise.

The definition of these two classes makes it possible to extract the useful information from the primary image.

The learning model used is a deep neural network which is particularly adapted to shape recognition. More specifically, the network used in this case is a U-NET-type convolutional neural network. It will be noted that another type of neural network could be used, and even another learning model.

In the industry, and in particular, in the aeronautic field, it is difficult to obtain the data necessary for the learning phase of a neural network. Therefore, a neural network architecture is used, which makes it possible to perform the segmentation of images for a small population of samples regarding the size of the databases usually used for learning deep neural networks.

The neural network used is constituted of discrete convolutional products (therefore, mainly multiplications and accumulations). The network is specialised in extracting patterns.

That is [symbol] ∈ [symbol] ₙ( [symbol] ) a square matrix of size n. To achieve a discrete convolution, a matrix of size k≤n less than [symbol] called kernel is introduced.

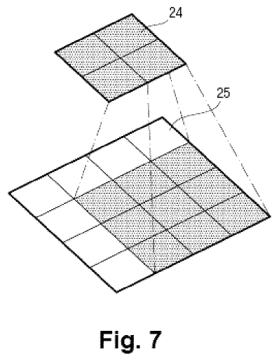

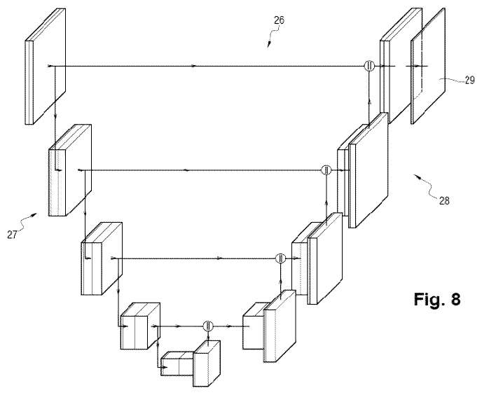

The convolutional kernel is applied to the image matrix by successive and ordered translations, which makes it possible to preserve the local structures of the patterns. In FIG. 7, a “simple” discrete convolutional product is illustrated, made by a convolutional kernel 24 applied onto the matrix 25 of the primary image.

It is noted that the structure of such a network is adapted to any image, even more so, to any matrix of square size. Thus, the method is not limited by the size of the series considered. In this case, the examples are developed with series having 1130 observations, but it is naturally possible to extend the method to series having any number of observations.

Naturally, a kernel adapted to the result sought is chosen, i.e. the detection of boundaries separating the patterns.

The principle architecture of the network used is described in FIG. 8.

The network 26 is constituted of two parts.

A part 27 (on the left in FIG. 8) makes it possible to compress the information and a part 28 (on the right in FIG. 8) makes m it possible to decompress this same information. Upon exiting the network, a segmented image, the value of the pixels of which represents, after standardisation, the probability of belonging to one of the two classes defined beforehand, is obtained. Indeed, the last layer of the network 29 is a softmax layer (standardised exponential function) which makes it possible to transform any number in an empirical probability.

The neural network 26 used operates similarly to those described in the document, Ronneberger, Olaf, Philipp Fischer and Thomas Brox (May 2015). “U-Net: Convolutional Networks for Biomedical Image Segmentation”. In: arXiv: 1505.04597 [cs]. arXiv: 1505. 04597 [cs].

It is noted that the passage through the images to characterise the time series, but also the fact that the operations implemented in the neural network used are mainly multiplications and accumulations, make the use of a GPU particularly relevant for implementing the invention. Consequently, in an advantageous embodiment of the processing unit 14 at the hardware level, this will comprise a GPU to implement the processing of the primary images (neural network), optionally as well as one or more other processing components for implementing all or some of the other steps of the partitioning method described in this case.

However, as has just been seen, it is possible that the quantity of data available for learning is insufficient. Therefore, the data is increased by generating primary images artificially, which improves the training of the network 26.

The processing unit 14 therefore uses an artificial generator to generate artificial images.

The artificial generator will instantiate a mathematical model of simulation functions, which therefore correspond to the dynamic of the signals studied, to simulate the performance of a real time series. In this case, the simulation functions are piecewise continuous constant functions. The simulation functions could be functions of a different type, and for example, multi-slope increasing functions.

The piecewise continuous constant functions each comprise a series of bearings of variable widths and of variable amplitudes. The widths give the dimensions of the square patterns and the amplitudes give the values of the pixels. This process simultaneously generates the pattern for learning (with shades of grey) and the binary target pattern (ground truth).

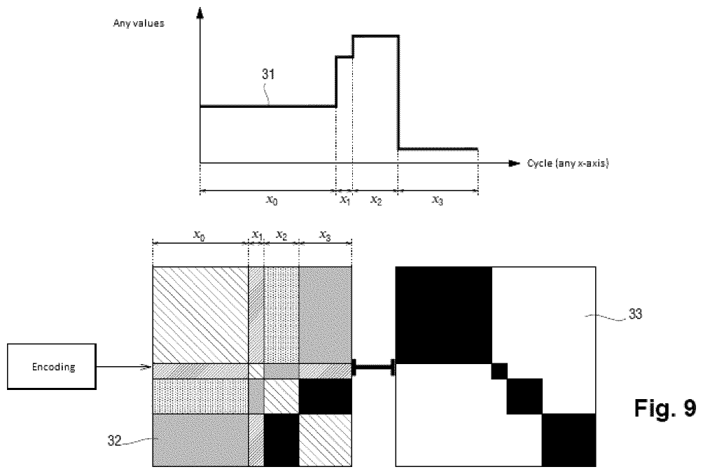

The encoding used above (creation of the distance matrix) is illustrated with artificial signals in reference to FIG. 9.

A piecewise continuous constant function 31 is generated. The function 31 comprises four bearings of variable widths (x₀, x₁, x₂, x₃) and of variable amplitudes. The function 31 is encoded by calculating a Gram matrix of said function. An artificial distance matrix and an artificial primary image 32 are obtained from said artificial distance matrix. Also, a mask 33 of the image is produced.

A few thousand images are thus generated for learning the neural network. The learning data are generated in grey levels. The mask 33 represents the ground truth that should produce the learning architecture. At each iteration of the learning, the result of the network will be compared to the mask 33.

The U-NET network will thus modify the value of its weights according to the error rate calculated between the “truth” and its output.

After the training phase, an architecture capable of identifying the sought patterns is created. The patterns are squares having a diagonal combined with a portion of the primary image.

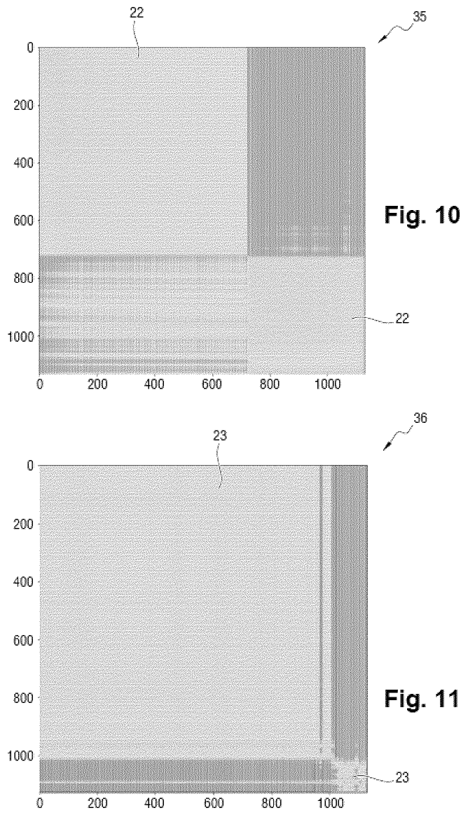

FIG. 10 represents a segmented image 35 resulting from the inference of the network on the primary image 20 of FIG. 5, while the U-NET network has been trained with purely artificial data. FIG. 11 represents a segmented image 36 resulting from the inference of the network on the primary image 21 of FIG. 6, while the U-NET network has been trained with purely artificial data. The square shape patterns 22 and 23 distinctly appear in FIGS. 10 and 11.

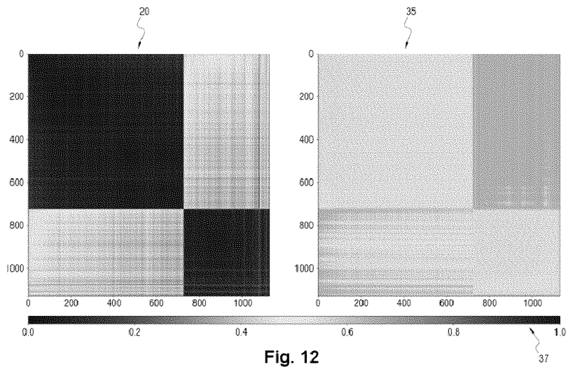

FIG. 12 represents the primary image 20 of FIG. 5 at the input of the network and the segmented image 35 at the output of the network, as well as a graph 37 representing the result of the segmentation.

The noise obtained in the segmented image could also be decreased by improving the training phase, and in particular by generating noisy data for learning. The process could also be completed by increasing the learning database with real data coming from a monitoring of the methods. It would also be possible to decrease the size of the learning database when the aggregation of new real data could reduce the relevance of certain pre-existing segments artificially constructed. A phase for trimming and reinforcing the database 17 would thus be carried out as the device is utilised.

It is noted that the learning of a deep structure with purely synthetic data enables a wider adoption of artificial intelligence methods in parsimonious data fields.

Therefore, it has just been explained how the processing unit 14 transforms each time series into a primary image, then produces from a primary image, a segmented image which shows the square patterns.

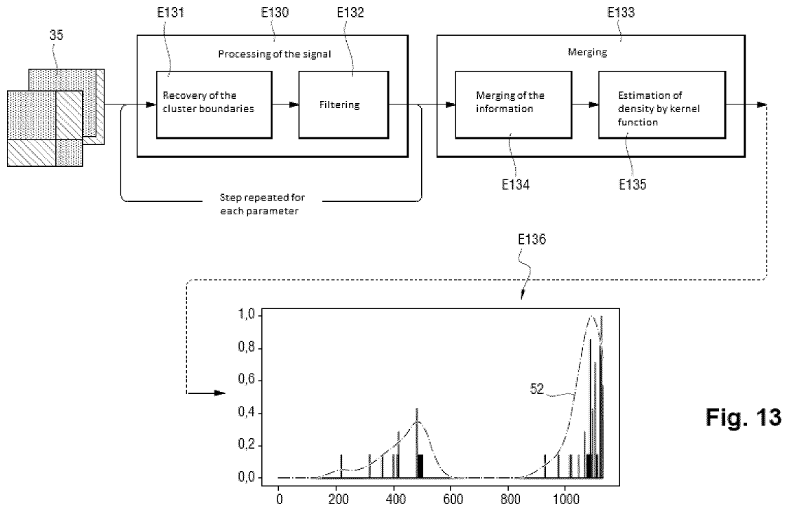

In reference to FIG. 13, when these steps have been carried out, signal processing operations (step E130) are implemented on segmented matrices 35 to recover the boundaries from the groups of pixels corresponding to the patterns (step E131 and step E43 in FIG. 4), and to filter the results obtained (step E132). These steps are carried out for all the segmented images, each associated with one of the parameters. These steps are followed by merging operations (step E133) which consist of merging the information (step E134 and step E44 in FIG. 4), and to estimate a density by kernel function (step E135 and step E45 in FIG. 4) to obtain a meta-signature (step E136).

It is noted that the steps E41 to E43 of FIG. 4 are repeated for each of the time series.

The extraction of the boundaries consists of producing, from each segmented image 35, a primary boundary signal representative of boundaries from the groups of pixels of said segmented image, then of filtering the primary boundary signal.

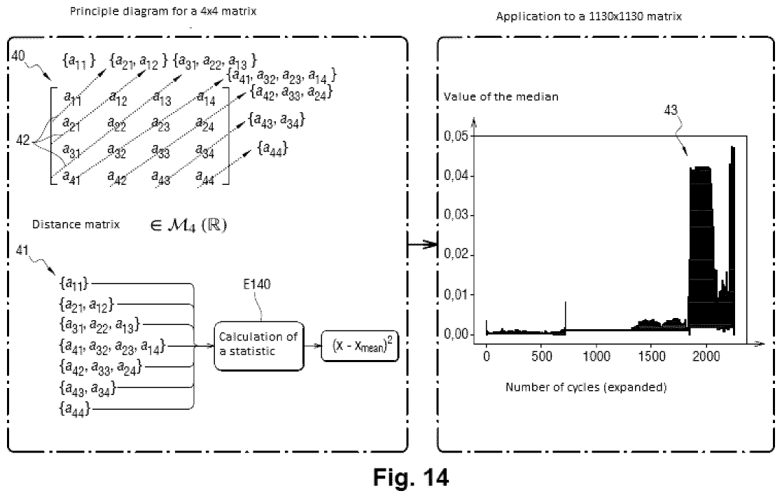

In reference to FIG. 14, the processing unit 14 produces, from each segmented image, associated with a parameter, a segmented matrix 40 which comprises the levels of the pixels of the segmented image. The construction of the primary boundary signal first consists of calculating a statistical function on sets of elements 41 which each comprise the elements of one of the anti-diagonals 42 of the segmented matrix 40 associated with said parameter (step E140).

The statistical function is, for example, the median function.

The interest of such a scrolling direction is to be able to make a reduction of dimension and to obtain a discriminatory group (or cluster) function.

The segmented matrix 40 is therefore travelled by increasing index along the opposite diagonal to obtain sets of successive elements 41 of increasing then decreasing length.

The statistic function is calculated for each set of elements 41. It thus takes a non-zero value instead of a group of pixels and zero at its boundaries (or conversely, according to the convention chosen).

Thus, for each segmented matrix 40, a primary boundary signal 43 is obtained, representative of the boundaries of the segmented matrix.

The primary boundary signal 43 thus obtained is extremely noisy and has its x-axis points expanded by a factor 2. In the case studied, the number of cycles passes from 1130 to 2259 (indeed, the diagonal of the segmented matrix not being counted twice, the x-axis is expanded by a factor two minus one to be exact), a direct consequence of the scrolling method used. For the 4×4 matrix represented, the number of sets of elements 41 is equal to 7 (=(2×4)−1).

The relevant information in the primary boundary signal 43 (i.e. the statistic calculated for each opposite diagonal) is contained in the peaks initiating a sudden variance change zone. The primary boundary signal 43 must be filtered to increase the signal/noise ratio and produce a signal only containing said peaks. However, the standard filtering methods require the non-trivial adjustment of intrinsic parameters such as the sliding window, i.e. the number of points to which the filter will be simultaneously applied. This window makes it possible to control the sensitivity of the algorithm with local or more global dynamics.

To overcome this uncertainty and make the result more systematic, a sliding window iterative method of increasing width (otherwise called dynamic batch peak detection) is developed.

This method uses a filter function which is a simple statistical function. In this case, the filter function is a maximum function, which could be modified according to the dynamics to highlight in the primary boundary signal.

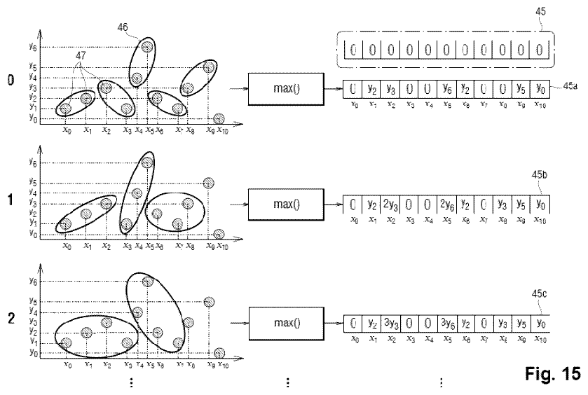

In reference to FIG. 15, this method comprises the following steps:
a current table 45 is defined, the size of which corresponds to the number of samples contained in the primary boundary signal (11 samples in the simplified example of FIG. 15), i.e. in the series of samples on which the statistic is calculated (in total, 2259 samples in our case);
the current table 45 is initialised to 0 (all its elements are zero);
a “current width” variable is initialised to 2;
windows 46 having, as a width, the current width are applied onto the series constituted by the samples 47 of the primary boundary signal, without coverage between the windows;
the maximum value is calculated for each window 46. The maximum value is obtained for one of the samples of said window 46. The maximum value is added to the element of the current table 45, the position of which in the current table 45 corresponds to the position of said sample in the series;
the current width is incremented by one unit;
the preceding steps are repeated, until the current width is equal to the size of the series.

On the first iteration, each window 46 therefore covers two samples then, at each iteration, the size of the windows 46 is incremented by one unit. The maximum value obtained on each window 46 is added to the element of the current table 45 corresponding to the cycle of the window where it is obtained, while the values of the other elements are preserved.

Thus, following the first iteration, the table 45a is obtained. It is seen that in each window 46 covering two samples 47, the maximum value between the two samples is preserved and is conferred to the element of the table 45a, the position of which in the vector corresponds to the position in the series of samples of the sample which has the maximum value of the window.

For example, for the window 46 which comprises the samples x₀ and x₁, the maximum corresponds to the value y₂ associated with x₁. The sample x₁ is in second position in the series, such that the second box of the table 45a takes the value y₂ (=0+y₂).

The zero value is added to the other element of the table 45a (the first) which remains the zero value.

Following the second iteration, the table 45b is obtained.

Following the third iteration, the table 45c is obtained.

This sequence is repeated for window sizes incremented by one unit each time until the window covers all of the series, i.e. of the primary boundary signal.

This filtering algorithm amplifies the local dynamics at the start of the loop to then tend to amplifying more global dynamics.

It is noted that, during the filtering of the signal by sliding window with incremental size, the maximum has been chosen in the method developed in this case. It is possible to select another statistic, for example the median, to highlight other dynamics of the signal.

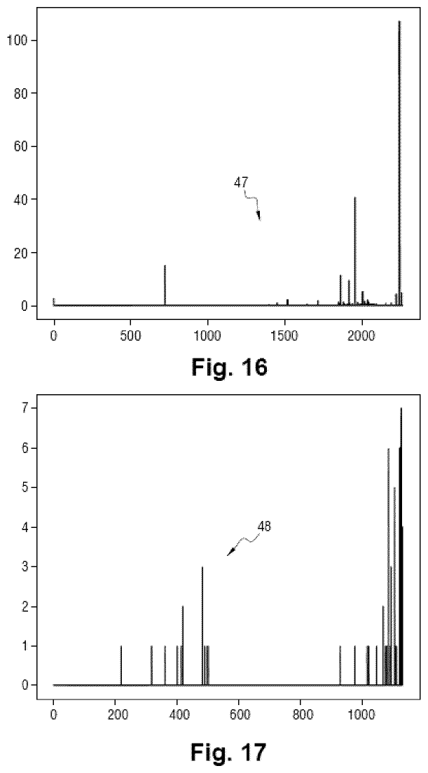

By dividing the x-axis points by two to overcome the expansion caused by the method of FIG. 14, the filtered primary boundary signal 47 which can be seen in FIG. 16 is obtained. The peaks clearly emerge.

The primary boundary signal obtained in FIG. 16 has zero values in places where the statistic of the algorithm has never been verified. The indices of the non-zero values are thus recovered.

As is, the latter have values of between [0; 2*n−1] and [0;1]. Such that the x-axis points of the signal are representative of reality, the integer part of the values obtained divided by two is calculated. The hypothesis is made that an accuracy of two cycles is tolerated for the calculations. Indeed, when the number of cycles if not a multiple of 2, this trivial reduction will have the effect of translating this point between two whole cycles.

Subsequently, a table of size less than n, that is 1130, containing these cycle values, is created.

A blank table of size precisely n is then initialised with zero values and unit values are added to the box referenced by each of the preceding numbers of cycles. The final table is therefore constituted of binary elements.

It is noted that the visible cycles in the primary boundary signal represent probable group boundaries.

The merging algorithm of primary boundary signals consists of summing the primary boundary signals to obtain a summed boundary signal, then to estimate an empirical density of the summed boundary signal to produce the global boundary signal.

The empirical density function can be oversampled. Also, theoretically, a continuous function will be created to estimate the shape of the plausibility of the group boundaries. Due to this, the loss of accuracy caused by the preceding method has anecdotal effects on the general method.

It is seen in FIG. 16 that clear boundaries appear around 800/2=400, 2000/2=1000 and 1100 cycles.

At this stage, the method can have two possible orientations according to the nature of the descriptor.

For a given descriptor:
either the amplitude is standardised between 0 and 1, which gives a weight to the peak in its vicinity;
or the value 1 is allocated to each peak, which gives the same weight to all the peaks.

The steps which have just been described are carried out for each parameter independently, and therefore p times in this case. The primary boundary signals, representative of the boundaries defining the square patterns, have therefore been produced then filtered for all the parameters.

A new matrix bringing together the concatenated boundary signals for each descriptor is obtained:

$$ℱ = [ \begin{matrix}{f}_{11} & {f}_{12} & {f}_{13} & … & {f}_{1 p} \\ {f}_{21} & {f}_{22} & {f}_{23} & … & {f}_{2 p} \\ ⋮ & ⋮ & ⋮ & ⋮ & ⋮ \\ {f}_{n 1} & {f}_{n 2} & {f}_{n 3} & … & {f}_{np}\end{matrix} ] ∈ {np}_{} ( ℝ ) .$$

The processing unit 14 will thus produce a global boundary signal from primary boundary signals.

The processing unit 14 uses, for this, an aggregation function to create new information by combining the data calculated previously. The processing unit 14 uses a kernel density estimation (KDE) to merge this information.

Hypotheses are thus formulated as regards the nature of the data handled (which are the time series calculated previously for each descriptor). The signals obtained are considered as embodiments of randomly sampled variables. Due to this, their distribution provides information about their theoretical probability density. The kernel function makes it possible to construct an empirical density which converges towards its theoretical density (subject to certain hypotheses on the kernel functions).

As has been seen, the data from the database used in the example described in this case, come from measurements of p parameters (statistical descriptors) taken on four pieces of equipment: the four jacks URA, ULA, LLA, LRA.

The implementation of the method according to the invention thus differs, according to which the measurements of the p parameters have been obtained on one same piece of equipment (or one same system) or on different equipment (or systems).

In the case where the measurements of the p parameters have been obtained on one same piece of equipment, i.e. in this case, on one same jack, the p descriptors are considered as p embodiments of one same random variable, themselves independent and identically distributed (iid).

In the case where the measurements of the p parameters have been obtained on different equipment, it is considered that each descriptor is a different random variable. The embodiments are always independent, but more identically distributed.

Therefore, two different methods of merging the information according to the reality to be modelled are obtained.

First, the case where the p descriptors are considered as p embodiments of one same random variable are viewed.

The values previously calculated linked to the peaks relating to each of the p descriptors can be summed: the processing unit 14 adds the filtered primary boundary signals, to obtain a summed boundary signal.

Thus, by considering the matrix [symbol] previously defined, a new vector is therefore calculated, such that:

$${( {x}_{i} )}_{1 \leq i \leq n} = {\sum }_{j = 1}^{p} {f}_{i j} .$$

The primary boundary signals are therefore summed to obtain a summed boundary signal forming a new time series [symbol] =(xᵢ)_{1≤i≤n}. The summed boundary signal 48 obtained for the LLA can be seen in FIG. 17.

The empirical density of this summed boundary signal 48 is thus calculated according to the following formula:

$$\hat{d} ( x ) = \frac{1}{n h} {\sum }_{i = 1}^{n} K ( \frac{x - {x}_{i}}{h} ) ,$$

where the xᵢ are the summed boundary signal elements, K is the kernel function, h represents a bandwidth of the kernel function, and n is a number of the elements of each time series.

K represents the kernel function applied to the variable centred at the point of the series sampled and scaled.

The kernel function can be of different types.

In this case, the Gaussian kernel function is used, which is of the form:

$$K = \frac{1}{\sqrt{2 π}} {exp}^{- \frac{1}{2} {x}^{2}} .$$

Thus, xᵢ with i∈ [symbol] 1;n [symbol] represents the continuation of the values taken by the random variable and x the current point of the estimated density. The density of the signal can be approached. The sum of the kernels is permitted by the hypothesis that the samples are identically distributed. The standardisation factor 1/m is then added to the expression. The element h, itself, represents the bandwidth of the kernel function. It is proportional to the support of the latter. It is noted that in the case of a Gaussian kernel function, the support is infinite, but h defines the spreading of the Gaussian.

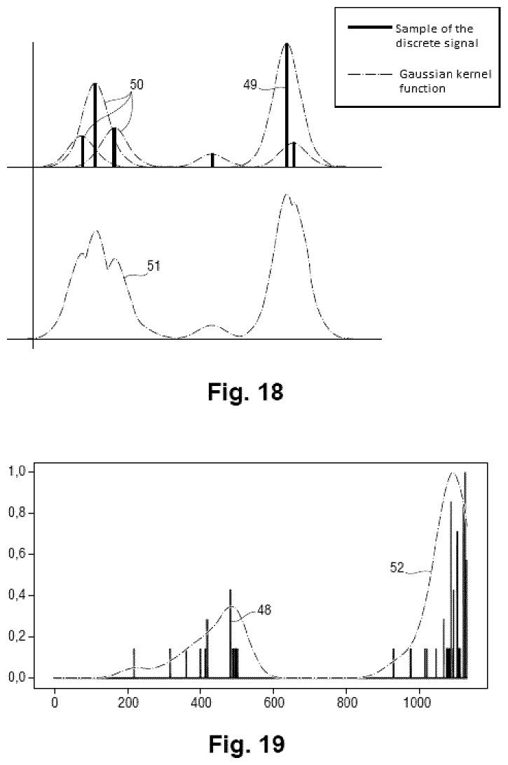

An example with a simplified discrete signal comprising six peaks 49 is seen in FIG. 18. The equation above results in a sum of densities 50 located at the points of the simplified discrete signal and generates a resulting signal 51.

By applying this principle to the summed boundary signal 48 which can be seen in FIG. 17, the empirical density 52 is obtained, which can be seen in FIG. 19, which constitutes the global boundary signal.

It is noted that the method requires the choice of two parameters: the kernel function and the value of the bandwidth.

For the kernel function, the Gaussian is selected for its theoretical properties.

Other kernel functions could be used, like for example, binomial functions like the Epanechnikov kernel. The latter would minimise the calculation load of the method.

The bandwidth is itself defined by the rule stated in the document, Silverman, Bernard W. (April 1986). Density Estimation for Statistics and Data Analysis. en. CRC Press. isbn: 978-0-412-24620-3. for a Gaussian kernel, namely h=0.9 An^{-1/5} with A=min(σ,écart inter-quartile/1.34). With the interquartile gap, the difference between the third and the first quartile in a series, in other words, a measurement of data dispersion.

The boundaries between the severity classes are defined by the maximums of the empirical density, i.e. of the global boundary signal 52. Therefore, three classes are distinguished in FIG. 19 (on both sides of the maximums).

By using the properties of the densities, it is possible to calculate the probability of occurrence of a group change and therefore of a boundary. It is sufficient for this to integrate the signal until the desired boundary.

The empirical density, i.e. the global boundary signal, thus represents a meta-signature which could subsequently characterise equipment or a system studied in the way of a descriptor.

Therefore, the state of a piece of equipment or of an embedded system in operation can be evaluated by using the global boundary signal, then the global boundary signal can be classified according to the classes defined in FIG. 19, and thus the health state of the equipment or of the system and its remaining useful life can be evaluated.

In the preceding step, the fact that the jacks URA, ULA, LRA and LLA represented the embodiments of one same random variable has been considered. Now, it is considered that the 4 jacks each represent a random variable, the boundary signals of each one can no longer be summed in this way, as nothing guarantees that the embodiments of the random variables considered are identically distributed. By extension, it can be considered that the 4 jacks represent 4 different systems to be monitored, therefore 4 different embodiments. The following formulas will be generalised, to consider the future plurality of equipment, for m embodiments therefore m dimensions for the estimation of density by kernels thus called multivaried.

Before presenting the general case, the estimation of density by two-dimensional multivaried kernels will be presented, for clarity.

That is d: [symbol] ²→ [symbol] the density function to be estimated in the case of two boundary signals and (x₁, y₁), . . . , (xₙ, yₙ) a sample of the density d. By using the modelling by kernels produced, the following estimation is obtained:

$$\hat{d} ( x , y ) = \frac{1}{n {h}_{1} {h}_{2}} {\sum }_{i = 1}^{n} K ( \frac{{X}_{i} - x}{{h}_{1}} ) K ( \frac{{Y}_{i} - y}{{h}_{2}} ) .$$

Thus, the variable x and y belong to the support of the estimated density and, in the case of dimension 2, it can be represented by a matrix. It is thus possible to generalise this formulation in dimension m in the case which is interesting by taking as a basis, the following formula applied to the elements of the matrix [symbol] :

$$\hat{d} ( {x}^{1} , … , {x}^{m} ) = \frac{1}{n {h}_{1} … {h}_{n}} {\sum }_{i = 1}^{n} \{ {\prod }_{j = 1}^{m} K ( \frac{{x}^{j} - {f}_{i j}}{{h}_{j}} ) \} ,$$

where the fᵢⱼ are elements of the primary boundary signals, K is a kernel function, the h₁ . . . hⱼ . . . hₙ represent a bandwidth of the kernel function, m is the number of embodiments not identically distributed and n is a number of elements of each time series.

This empirical density forms the global boundary signal in the case which is interesting.

From this equation, it becomes possible to enhance the density calculation made above by making the hypothesis that the embodiments of random variables considered come from different distributions. For the ETRAS® system, it would thus be interesting to give hypotheses of modelling on several levels, according to which the system is considered as being a complete ETRAS® system or a set of jacks.

In this example, if each of the four jacks is considered as a system, it is thus not trivial to consider that the values of the vibratory signals of each of the jacks follow one same distribution law. Indeed, the jacks are not used uniformly on the system. To improve the reliability of the information obtained with the meta-signature of FIG. 19, the information of the four different jacks must thus be merged. A weighting at the descriptors of each of the electromechanical actuators can thus be applied, while the multivaried estimated density will be considered as a Gaussian mixture (in the case of a Normal kernel function).

In the preceding equation, the information provided by each descriptor is weighted identically. It could be interesting to allocate a specific weight to certain descriptors. Each kernel function would be weighted by ϕᵢ, i∈ [symbol] 1; m [symbol] such that Σᵢ₌₁^{m}ϕᵢ=1 to preserve a probability mass function. The estimation of density by multivaried kernel could thus be written in the form:

$$\hat{d} ( {x}^{1} , … , {x}^{m} ) = \frac{1}{n {h}_{1} … {h}_{n}} {\sum }_{i = 1}^{n} \{ {\prod }_{j = 1}^{m} {Φ}_{j} K ( \frac{{x}^{j} - {x}_{i j}}{{h}_{j}} ) \} .$$

The merging of information presented makes it possible to create a meta-signature representing the function of belonging to considered data groups. This method makes it possible to consider the provision of data of different systems (for several ETRAS®) or also the provision of data for several actuators (if jacks are viewed).

As has been seen, and by returning to FIG. 4, determining the maximums (step E46 in FIG. 4) makes it possible to obtain the number of severity classes. The processing unit 14 stores the results in the memory 16 (step E47).

Thus, it is understood that the step of merging data 45 makes it possible to produce a meta-signature for each piece of equipment (in this case, each jack URA, ULA, LRA and LLA), but also a global meta-signature which considers observations produced for each of these pieces of equipment.

Therefore, the estimation of the health state and of the remaining useful life of a subject piece of equipment (or of a subject system) is improved by using observations obtained on different equipment (or systems) which are close, but not necessarily identical to said subject piece of equipment (and which can differ from one another).

It is naturally advantageous to format the labels for each point of each time series (step E48), so as to produce labelled data. The labelled data are thus reintroduced into the database 17 (step E50).

Naturally, the invention is not limited to the embodiment described, but covers any variant coming within the scope of the invention such as defined by the claims.

1. A partitioning method, implemented in a processing unit and comprising the steps of:
acquiring an observation matrix produced from a database comprising observations of parameters made on at least one piece of equipment, the observation matrix comprising time series (x₁, x₂, . . . , xₚ) each comprising elements which are observations of a parameter;
for each time series:
calculating a distance matrix comprising distance values between the elements of the time series, then generating a primary image on the basis of said distance matrix, comprising pixels having levels representative of the distance values of the distance matrix;
implementing a learning algorithm for segmenting the primary image so as to obtain a segmented image comprising patterns delimited by boundaries, and producing a segmented matrix comprising levels of pixels of the segmented image;
defining from the segmented matrix, a primary boundary signal representative of the boundaries;
merging the primary boundary signals to obtain a global boundary signal, and defining classes from the global boundary signal.

2. The partitioning method according to claim 1, wherein the distance matrix is a Gram matrix, such that:
$$𝒢 ( {𝕏}_{i} ) = [ \begin{matrix}d ( {x}_{1}^{i} , {x}_{1}^{i} ) & d ( {x}_{1}^{i} , {x}_{2}^{i} ) & … & d ( {x}_{1}^{i} , {x}_{n}^{i} ) \\ d ( {x}_{2}^{i} , {x}_{1}^{i} ) & d ( {x}_{2}^{i} , {x}_{2}^{i} ) & … & d ( {x}_{2}^{i} , {x}_{n}^{i} ) \\ ⋮ & ⋮ & ⋮ & ⋮ \\ d ( {x}_{n}^{i} , {x}_{1}^{i} ) & d ( {x}_{n}^{i} , {x}_{2}^{i} ) & … & d ( {x}_{n}^{i} , {x}_{n}^{i} )\end{matrix} ] ,$$
where [symbol] ᵢ is a time series, the (xₖⁱ)_{1≤k≤n} are the elements of said time series, and where d(xₗⁱ, xₘⁱ) is a distance value between xₗⁱ and xₘⁱ, with 1≤l≤n and 1≤m≤n.

3. The partitioning method according to claim 2, wherein the patterns are squares having a diagonal combined with a portion of a diagonal of the primary image.

4. The partitioning method according to claim 1, wherein the segmentation of the primary image consists of determining a probability of belonging of the pixels of the primary image to a first class representing the patterns or to a second class representing a background of the primary image.

5. The partitioning method according to claim 1, wherein the learning algorithm is a U-NET-type convolutional neural network.

6. The partitioning method according to claim 1, further comprising the step of generating artificial primary images from simulation functions, and of training the learning algorithm by using the artificial primary images.

7. The partitioning method according to claim 6, wherein the simulation functions are piecewise continuous constant functions of multi-slope increasing functions.

8. The partitioning method according claim 1, wherein the definition of the primary boundary signal comprises the step of calculating a statistical function on sets of elements which each comprise elements of one of the anti-diagonals of the segmented matrix.

9. The partitioning method according to claim 8, further comprising the step of filtering the primary boundary signal by using a sliding window iterative method.

10. The partitioning method according to claim 1, wherein the merging of the primary boundary signals consists of summing the primary boundary signals to obtain a summed boundary signal, then of estimating an empirical density function of the summed boundary signal to produce the global boundary signal.

11. The partitioning method according to claim 10, wherein, to calculate the empirical density function, a first formula is used in the case where the observations of parameters have been made on one same piece of equipment or system, and a second formula is used in the case where the observations of parameters have been made on distinct equipment or systems representing embodiments not identically distributed.

12. The partitioning method according to claim 11, wherein the first formula is:
$$\hat{d} ( x ) = \frac{1}{n h} {\sum }_{i = 1}^{n} K ( \frac{x - {x}_{i}}{h} ) ,$$
where the xᵢ are elements of the summed boundary signal, K is a kernel function, h represents a bandwidth of the kernel function and n is a number of elements of each time series.

13. The partitioning method according to claim 11, wherein the second formula is:
$$\hat{d} ( {x}^{1} , … , {x}^{m} ) = \frac{1}{n {h}_{1} … {h}_{n}} {\sum }_{i = 1}^{n} \{ {\prod }_{j = 1}^{m} K ( \frac{{x}^{j} - {f}_{i j}}{{h}_{j}} ) \} ,$$
where the fᵢⱼ are elements of the primary boundary signals, K is a kernel function, the h₁ . . . hⱼ . . . hₙ represent a bandwidth of the kernel function, m is a number of embodiments not identically distributed and n is a number of elements of each time series.

14. The partitioning method according to claim 11, wherein the second formula is:
$$\hat{d} ( {x}^{1} , … , {x}^{m} ) = \frac{1}{n {h}_{1} … {h}_{n}} {\sum }_{i = 1}^{n} \{ {\prod }_{j = 1}^{m} {Φ}_{j} K ( \frac{{x}^{j} - {x}_{i j}}{{h}_{j}} ) \} ,$$
where the fᵢⱼ are elements of the primary boundary signals, K is a kernel function, the h₁ . . . hⱼ . . . hₙ represent a bandwidth of the kernel function, m is a number of embodiments not identically distributed, n is a number of elements of each time series, and wherein the following is had:
ϕᵢ,i∈ [symbol] 1;m [symbol] and Σᵢ₌₁^{m}ϕᵢ=1.

15. A processing unit comprising at least one processing component, wherein the partitioning method according to claim 1 is implemented.

16. The processing unit according to claim 15, comprising a GPU, wherein at least the learning algorithm is implemented to segment the primary images.

17. (canceled)

18. A non-transitory computer-readable medium on which a computer program comprising instructions which make a processing unit execute the steps of the partitioning method according to claim 1 is recorded.
